(19) United States
(12) Patent Application Publication
(10) Pub. No.: US 2011/0252691 A1
(43) Pub. Date: Oct. 20, 2011

(54) DIVING PLANER FOR FISHING

(76) Inventor: Daniel L. Heyne, Coldwater, OH (US)

(21) Appl. No.: 13/089,565

(22) Filed: Apr. 19, 2011

Related U.S. Application Data
(60) Provisional application No. 61/325,613, filed on Apr. 19, 2010.

(51) Int. Cl. A01K 91/06

(52) U.S. Cl. 43/43.13

(57) ABSTRACT

A diving planer is provided for use in a fishing environment. The diving planer includes a planer body that is adapted to be drawn through a body of water. The planer body is operable between a first mode of operation, wherein the planer body is configured to travel in a first direction when drawn through the body of water, and a second mode of operation, wherein the planer body is configured to travel in a second direction when drawn through the body of water.

### CROSS-REFERENCE TO RELATED APPLICATIONS

This application claims the benefit of U.S. Provisional Application No. 61/325,613, filed Apr. 19, 2010, the disclosure of which is incorporated herein by reference.

### BACKGROUND OF THE INVENTION

This invention relates in general to fishing equipment. In particular, this invention relates to an improved structure for a diving planer that is operable between a first mode of operation, wherein the diving planer is configured to travel through the water in a first direction, and a second mode of operation, wherein the diving planer is configured to travel through the water in a second direction.

Trolling is a commonly known method of fishing where one or more fishing lines are drawn through a body of water by a moving boat. For example, the fishing line can be wound on a reel that is, in turn, mounted to a fishing pole. The fishing pole can be held by a fisherman positioned in the boat or otherwise attached to the boat for movement therewith. A lure or baited hook is secured to an end of the line. As the lure is drawn through the water by the moving boat, it is configured to resemble prey of a fish for enticing the fish to attack the lure.

Various species of fish are known to swim at different depths. As such, it has been found desirable to maintain the lure at a desired depth while trolling for a particular species. One example of a known device for accomplishing this is commonly referred to as a diving planer. A typical diving planer is attached to an end of the fishing line and includes a body portion having wings that extend outwardly from the body. As the diving planer is drawn through the water by the fishing line, the diving planer is configured to pull the end of the fishing line downwardly to a desired depth. However, retrieval of the fishing line and lure can be somewhat difficult as a result of the downward pulling action of the diving planer as it is drawn through the water. Although known diving planers function in an acceptable manner, it would be desirable to provide an improved structure for a diving planer that includes a release mechanism.

### SUMMARY OF THE INVENTION

This invention relates to an improved structure for a diving planer for use in a fishing environment. The diving planer includes a planer body that is adapted to be drawn through a body of water. The planer body is operable between a first mode of operation, wherein the planer body is configured to travel in a first direction when drawn through the body of water, and a second mode of operation, wherein the planer body is configured to travel in a second direction when drawn through the body of water.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a side elevational view of a fishing environment illustrating a conventional diving planer and lure.

FIG. 2 is an enlarged perspective view of the conventional diving planer illustrated in FIG. 1.

FIG. 3 is a perspective view of an improved diving planer showing a release member in a first operational position in accordance with this invention.

FIG. 4 is a side elevational view, partially broken away, of the diving planer illustrated in FIG. 3 showing the release member in the first operational position.

FIG. 5 is a side elevational view, partially broken away, of the diving planer illustrated in FIG. 3 showing the release member in a second operational position.

FIG. 6 is a top plan view of a portion of the diving planer illustrated in FIGS. 3, 4, and 5 without the release member.

### DETAILED DESCRIPTION OF THE PREFERRED EMBODIMENT

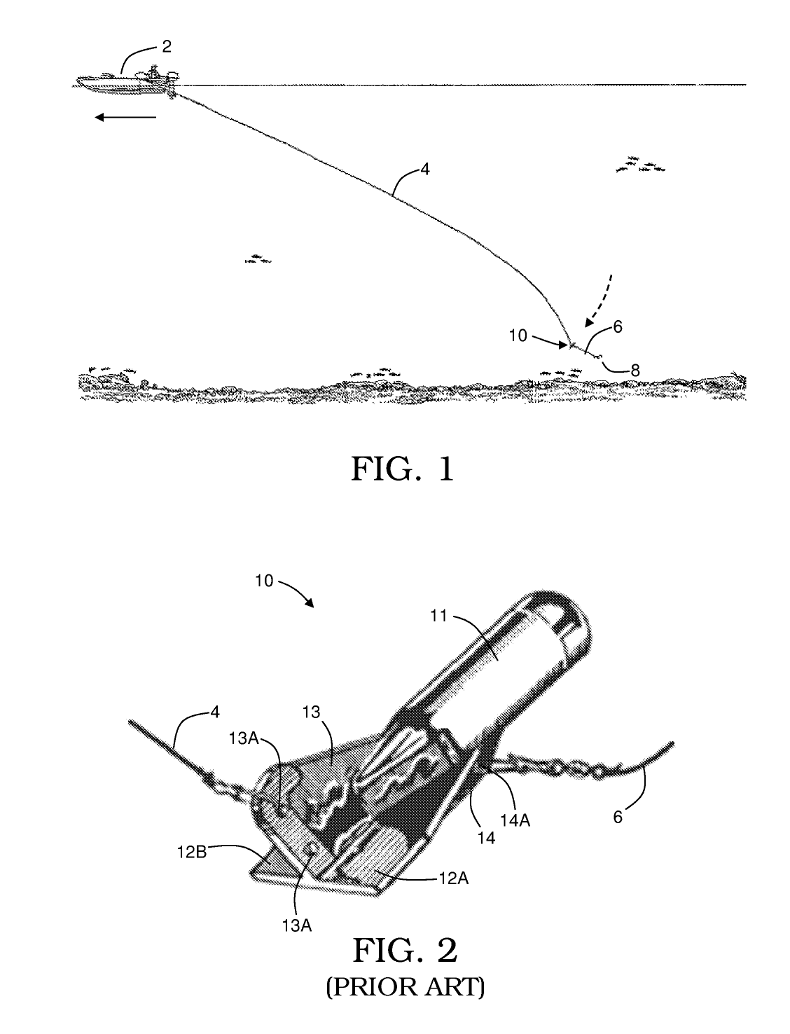

Referring now to the drawings, there is illustrated in FIG. 1 a side elevational view of a fishing environment wherein a conventional diving planer, indicated generally at 10, is being used for fishing. The fishing environment can be any body of water, such as a river, lake, or ocean for example. As shown, a boat 2 is provided for movement along a surface of the water, although such is not required. The boat 2 is configured to draw a fishing line 4 through the body of water as it travels along the surface thereof, such as when trolling. For example, the fishing line 4 can be wound on a reel (not shown) that is, in turn, mounted to a fishing pole or rod (also not shown). The fishing pole can be held by a fisherman positioned in the boat 2 or else attached to the boat 2 for movement therewith. However, it should be appreciated that the fishing line 4 can be drawn through the body of water in any manner including, for example, actuation of the reel or by water current.

The diving planer 10 is tied or otherwise secured to the fishing line 4 near an end thereof. A lure 8 or baited hook can be connected to the diving planer 10 by a leader line 6, which may extend any length between the diving planer 10 and the lure 8. The lure 8 can be any conventional fishing lure that is designed to attract a desired species of fish. For example, the lure 8 can be configured to resemble prey of a fish for enticing the fish to attack and bite the lure 8. As the diving planer 10 is drawn through the body of water by the fishing line 4, it is adapted to pull the end of the fishing line 4 downwardly in the water to a desired depth, as shown by the broken arrow in FIG. 1. It should be appreciated that the diving planer 10 can be adapted to maintain the lure 8 at any depth for a desired fishing environment.

Referring now to FIG. 2, a structure of the conventional diving planer 10 is illustrated. The diving planer 10 includes a body 11 having a pair of wing portions 12A and 12B extending laterally away from the body 11. A first fin 13 extends upwardly from the body 11 and has one or more openings 13A formed therethrough. A second fin 14 extends downwardly from the body 11 and has one or more openings 14A formed therethrough.

An end of the fishing line 4 is looped through one of the openings 13A formed through the first fin 13 and is knotted or otherwise secured thereto. The leader line 6 is looped through one of the openings 14A formed through the second fin 14 and is knotted or otherwise secured thereto. Alternatively, the fishing line 4 and the leader line 6 can be secured to the respective openings 13A, 14A of the diving planer 10 by a snap connector or swivel if so desired.

As briefly described above, the conventional diving planer 10 is adapted to pull the end of the fishing line 4 downwardly in the body of water to a desired depth. It should be appreciated that the depth maintained by the diving planer 10 can be controlled by adjusting a variety of characteristics, such as the speed at which the diving planer 10 is pulled through the body of water, the length of fishing line 4 released from the reel, the weight of the fishing line 4, and the angular relationship of the wing portions 12A and 12B relative to the fishing line 4 and the body 11.

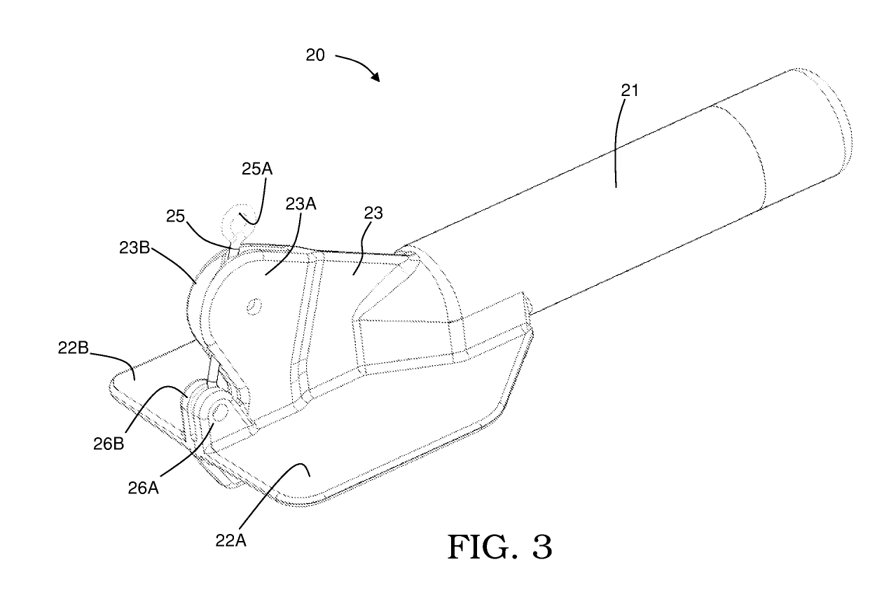

Referring now to FIGS. 3 through 6, there is illustrated an improved structure for a diving planer, indicated generally at 20, in accordance with this invention. The diving planer 20 can be used in the fishing environment as described above in FIG. 1 or any other suitable environment. As will be explained below, the diving planer 20 is operable between a first mode of operation and a second mode of operation. In the first mode of operation, the diving planer 20 is configured to travel through the body of water in a first direction, such as downwardly for example. In the second mode of operation, the diving planer 20 is configured to travel through the body of water in a second direction, such as upwardly for example. However, the diving planer 20 may alternatively be adapted to travel in any desired directions and can be used to accomplish any desired purpose.

The diving planer 20 can be any planer body that is adapted for directional travel when drawn through the body of water. For example, the illustrated diving planer 20 includes a body portion 21 and a pair of wing portions 22A and 22B. As shown, the body portion 21 is a cylindrical member that axially extends from the wing portions 22A and 22B. Alternatively, the body portion 21 may define any other shape or configuration for a desired application. It should also be appreciated that the diving planer 20 need not include the body portion 21 if so desired.

The illustrated wing portions 22A and 22B are generally flat structures that laterally extend away from one another and the body portion 21. As shown, the wing portions 22A and 22B are positioned along a bottom surface of the body portion 21 and extend in a forward direction therefrom. The respective wing portions 22A and 22B can extend at any angular relationship relative to the body portion 21 for selectively adjusting the depth at which the diving planer 20 travels through the water. Further, the wing portions 22A and 22B can define any shape (such as a contoured surface, for example) or be positioned in any location relative to the body portion 21.

The illustrated diving planer 20 also includes a first fin 23. The first fin 23 may form a generally narrow wall that perpendicularly extends upwardly from the body portion 21 and a top surface of the wing portions 22A and 22B. However, the first fin 23 may extend at any angular relationship relative to the body portion 21 and the wing portions 22A and 22B. The illustrated first fin 23 is partially split, having a first portion 23A and a second portion 23B that extend generally parallel to one another to form a gap therebetween. It should be appreciated that the first fin 23 may be otherwise configured for any purpose and is not required for this invention.

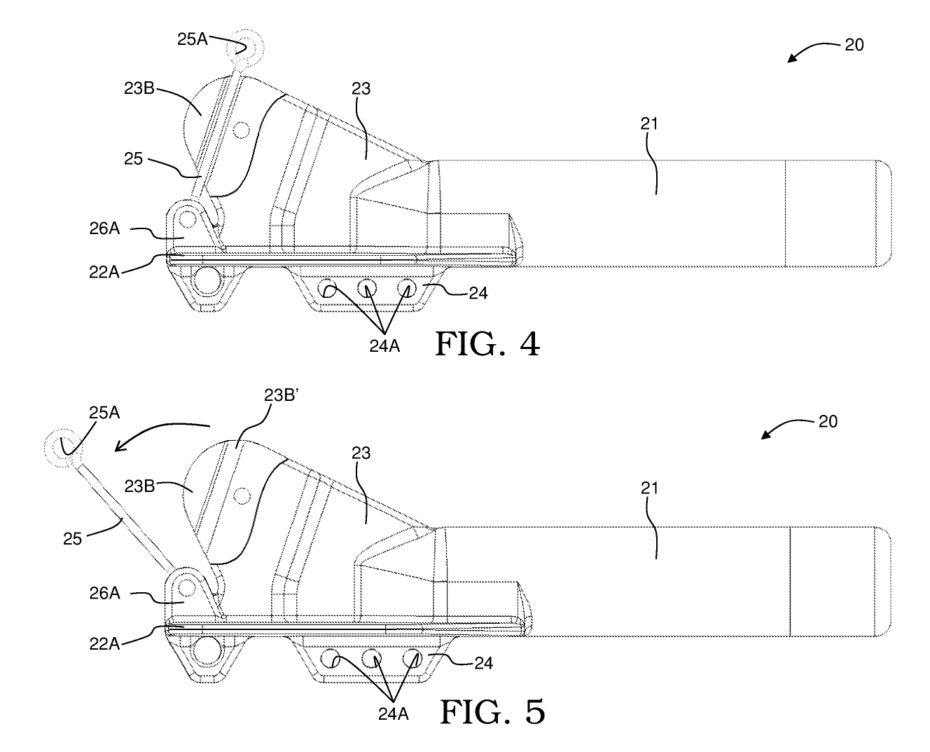

As shown in FIGS. 4 and 5, the illustrated diving planer 20 also includes a second fin 24. The second fin 24 perpendicularly extends downwardly from the body portion 21 and a bottom surface of the wing portions 22A and 22B. One purpose of the second fin 24 is to secure a leader line (not shown) to the diving planer 20. As such, the second fin 24 may include one or more openings 24A formed therethrough. It should be appreciated that the second fin 24 may be otherwise configured for any purpose and is not necessary for this invention.

Referring back to FIG. 3, the illustrated diving planer 20 also includes a release member 25. The illustrated release member 25 is a cylindrical arm or the like having any length. The illustrated release member 25 is pivotally supported by a pair of support walls 26A and 26B for movement between a first actuating position and a second actuating position. To accomplish this, the release member 25 may include a first eyelet or looped end (not shown) located at a first end thereof. The looped end is configured to receive a fastener that can be inserted through a pair of apertures formed in the respective support walls 26A and 26B. In other embodiments, the release member 25 can be supported for any type of movement between the first actuating position and the second actuating position.

As shown, the support walls 26A and 26B extend from an upper surface of the respective wing portions 22A and 22B such that the release member 25 is located near the first fin 23. However, the release member 25 may be supported on any portion of the diving planer 20 for any desired movement relative thereto. As will be described below, the first actuating position is illustrated in FIGS. 3 and 4, while the second actuating position is illustrated in FIG. 5.

The illustrated release member 25 also includes a second eyelet or looped end 25A located at a second end thereof. One purpose of the looped end 25A is to secure the diving planer 20 to the fishing line (not shown) that extends from the fishing pole (also not shown) so as to be drawn through the body of water. Accordingly, an end of the fishing line can be threaded through the looped end 25A and knotted or otherwise secured thereto. In other embodiments, however, the fishing line can be secured to the release member 25 in any manner such that the looped end 25A is not necessary.

A leader line (not shown) can be threaded through one of the openings 24A formed through the second fin 24 and knotted or otherwise secured thereto, although such is not required. As described above, the leader line is configured to connect a conventional lure (not shown) to the diving planer 20. Thus, the leader line may extend any length between the diving planer 20 and the lure for a desired fishing environment. Further, it should be appreciated that numerous other configurations can be used to secure the diving planer 20 and the lure to the fishing line.

The illustrated diving planer 20 can be formed from any generally resilient material that is preferably buoyant, although such is not required. In addition, any portions of the diving planer 20 may be integrally formed together as a single unit to form the planer body, such as the body portion 21, the wing portions 22A and 22B, the first fin 23, and the second fin 25. For example, the diving planer 20 may be formed from a plastic material using any molding process or the like, wherein the release member 25 is subsequently secured thereto. Alternatively, the diving planer 20 can be assembled from any number of individual components or can be machined from a single piece of material.

Referring now to FIG. 4, the diving planer 20 is illustrated in the first actuating position. As shown, the release member 25 is initially engaged between the first and second portions 23A, 23B of the first fin 23. While the release member 25 is in the first actuating position, the diving planer 20 is oriented in such a manner as to pull the end of the fishing line downwardly in the body of water to a desired depth as it is drawn through the water. It should be appreciated that the depth maintained by the diving planer 20 can be controlled by adjusting a variety of characteristics, such as the speed at which the diving planer 20 is pulled through the water, the length of fishing line released from the reel, the weight of the fishing line, and the angular relationship of the wing portions 22A and 22B relative to the fishing line and the body portion 21. This enables the lure (not shown) to be maintained at a desired depth.

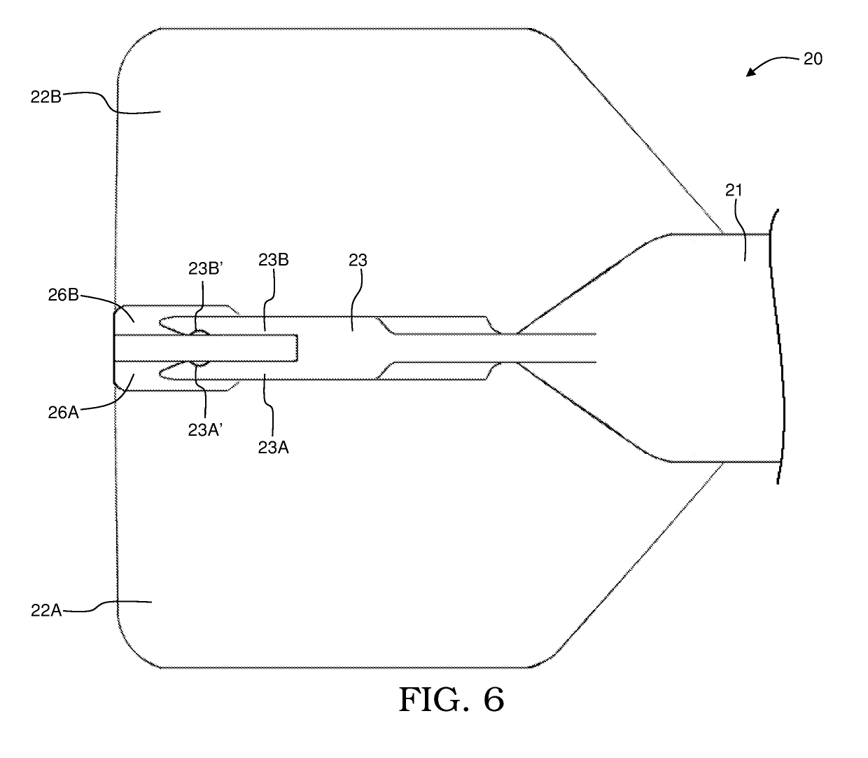

Referring now to FIG. 6, a securing device is provided for normally maintaining the release member 25 in the first actuating position as illustrated in FIGS. 3 and 4. For example, each of the first and second portions 23A, 23B of the first fin 23 may include a recessed area 23A′ and 23B′ provided therein. As shown, the recessed areas 23A′ and 23B′ are each generally semi-cylindrical in shape, although such is not required. The recessed areas 23A′ and 23B′ are oriented in such a manner that when the release member 25 (not shown) is in the first actuating position, the release member 25 is releasably secured within the recessed areas 23A′ and 23B′. For example, the recessed areas 23A′ and 23B′ each defines a linear groove that extends along inner surfaces of the respective first and second portions 22A and 22B so as to oppose one another. It should be appreciated that the diving planer 20 may alternatively include protrusions, a clip, or any other structure for releasably securing the release member 25 in the first actuating position.

When a fish grabs the lure that is connected to the diving planer 20, a force of increased magnitude is exerted on the release member 25. As a result, the release member 25 is automatically pivoted out of the first actuating position to the second actuating position, as explained below. It should be appreciated that the release member 25 is adapted to move from the first actuating position to the second actuating position in response to a force that is greater than the force normally required to draw the diving planer 20 through the body of water in the first mode of operation.

Referring now to FIG. 5, the diving planer 20 is illustrated in the second actuating position. As shown, the release member 25 is no longer engaged between the first and second portions 23A, 23B of the first fin 23. While the release member 25 is in the second actuating position, the diving planer 20 is oriented in such a manner as to pull the end portion of the fishing line upwardly toward the surface of the body of water, thereby facilitating retrieval of the fish.

Once the fish has been retrieved by the fisherman, the release member 25 can be pivoted from the second actuating position back to the first actuating position. To facilitate receipt of the release member 25 between the first and second portions 23A, 23B of the first fin 23, the leading edges of the first and second portions 23A, 23B can be chamfered or otherwise splayed open, although such is not required. The diving planer 20 is again ready for use. This process can be continually repeated any number of times.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A diving planer for use in a fishing environment comprising:
a planer body that is adapted to be drawn through a body of water, the planer body being operable between a first mode of operation, wherein the planer body is configured to travel in a first direction when drawn through the body of water, and a second mode of operation, wherein the planer body is configured to travel in a second direction when drawn through the body of water.

2. The diving planer of claim 1, further including a release member that is mounted to the planer body for movement between a first position, wherein the planer body is configured to travel in the first direction, and a second position, wherein the planer body is configured to travel in the second direction.

3. The diving planer of claim 2, wherein the planer body is adapted to be drawn through the body of water by the release member.

4. The diving planer of claim 2, wherein the release member is pivotally mounted to the planer body.

5. The diving planer of claim 2, further including at least one support wall that is mounted on the planer body and adapted to pivotally attach the release member to the planer body.

6. The diving planer of claim 2, further including a securing device that is mounted to the planer body and adapted to releasably secure the release member in the first position.

7. The diving planer of claim 6, wherein the securing device extends outwardly from the planer body.

8. The diving planer of claim 6, wherein the securing device includes a first portion and a second portion that are adapted to releaseably secure the release member therebetween.

9. The diving planer of claim 8, wherein at least one of the first portion and the second portion of the securing device includes a recessed area that is adapted to receive the release member.

10. A diving planer for use in a fishing environment comprising:
a planer body that is adapted to be drawn through a body of water; and
a release member that is mounted to the planer body for movement between a first position, wherein the planer body is positioned in a first orientation when drawn through the body of water for travel in a first direction, and a second position, wherein the planer body is positioned in a second orientation when drawn through the body of water for travel in a second direction.

11. The diving planer of claim 10, wherein the planer body is adapted to be drawn through the body of water by the release member.

12. The diving planer of claim 10, wherein the release member is pivotally mounted to the planer body.

13. The diving planer of claim 10, further including at least one support wall that is mounted on the planer body and adapted to pivotally attach the release member to the planer body.

14. The diving planer of claim 10, further including a securing device that is mounted to the planer body and adapted to releasably secure the release member in the first position.

15. The diving planer of claim 14, wherein the securing device extends outwardly from the planer body.

16. The diving planer of claim 14, wherein the securing device includes a first portion and a second portion that are adapted to releaseably secure the release member therebetween.

17. The diving planer of claim 15, wherein at least one of the first portion and the second portion of the securing device includes a recessed area that is adapted to receive the release member.
